(19) United States
(12) Patent Application Publication
(10) Pub. No.: US 2009/0273928 A1
(43) Pub. Date: Nov. 5, 2009

(54) DECORATIVE LIGHT STRING

(76) Inventor: Melissa C. Rizopoulos, Oswego, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 12/355,416

(22) Filed: Jan. 16, 2009

Related U.S. Application Data
(60) Provisional application No. 61/011,297, filed on Jan. 16, 2008.

(51) Int. Cl. F21S 4/00

(52) U.S. Cl. 362/249.16

(57) ABSTRACT

A decorative lighting article is disclosed. The article includes a string of lights, such as miniature bulbs for holiday lighting. A mesh sleeve is placed substantially surrounding the string of lights. The mesh sleeve is preferably flexible and translucent. Thus, light passing through it is diffused and creates a unique appearance. The sleeve may be colored or clear. Ideally it is formed of a flexible material such as a nylon material. Additional decorative items may be attached to the exterior of the sleeve, such as ribbons or trinkets. Preferably, the sleeve is non-flammable.

### CROSS REFERENCES

This application claims the benefit of U.S. Provisional Application No. 61/011,297, filed Jan. 16, 2008, which is hereby incorporated by reference herein in its entirety.

### BACKGROUND OF THE INVENTION

1. Field of the Invention

The present invention relates, in general, to decorative lighting for holidays and the like and, more particularly, this invention relates to an attractive flexible mesh sleeve around a string of lights to enhance the shape and appearance of the lighting.

2. Background

Prior to the conception and development of the present invention, decorative lighting for holidays, weddings, and the like have been a string of uncovered electric bulbs that are wrapped around or attached to items to be decorated, such as trees. In recent years, lights encased in clear flexible tubing have been marketed as rope lights. While these create an orderly uniform ribbon of lights, not much else is done to improve the appearance around the lights themselves. Hermanson in U.S. Pat. No. 4,885,664 teaches encasing lights in a generally tubular sheath. Law in U.S. Pat. No. 6,352,355 teaches forming a decorative, internally-lighted ribbon of lights encased in a hollow elongated sleeve of translucent material.

Accordingly, there remains a need for a decorative string of lights which is encased in a way which makes them more pleasing and provides various other features and advantages.

### SUMMARY

It is, therefore, one of the primary objects of the present invention to enhance the aesthetics of holiday lighting.

Another object of the present invention is to provide an economical method of enhancing the appearance of existing strings of miniature ornamental lights.

Still another object of the present invention is to economically produce a unique decorative lighting structure.

Yet another object of the present invention is to provide enhanced decorative lighting readily formed and attached to various structures.

The present invention provides an enhanced form of decorative lighting by encasing a string of lights along at least a portion of its length with an elongated sleeve of flexible, irregular shaped mesh. When the lights are lit, the mesh or netting diffuses the light in aesthetically pleasing ways. The lights may be clear, white, or colored, or any combination thereof. A nylon mesh is the preferred material of the sleeve.

Other features and advantages of the invention will be apparent from the following detailed description taken in conjunction with the following drawings wherein like reference numerals represent like features.

### BRIEF DESCRIPTION OF THE DRAWINGS

FIG. 1 is a front elevation view of a portion of an electrical string of lights in a preferred embodiment of the invention.

FIG. 2 is a perspective view of an embodiment of the invention decorating an archway between two rooms.

FIG. 3 is a perspective view of an embodiment of the present invention adorning a railing.

FIG. 4 is a plan view of a battery-powered version of the invention.

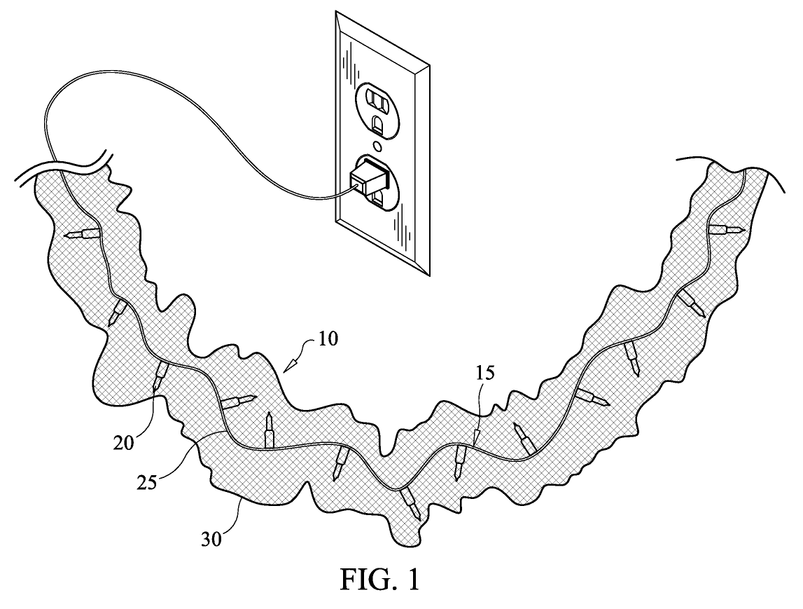

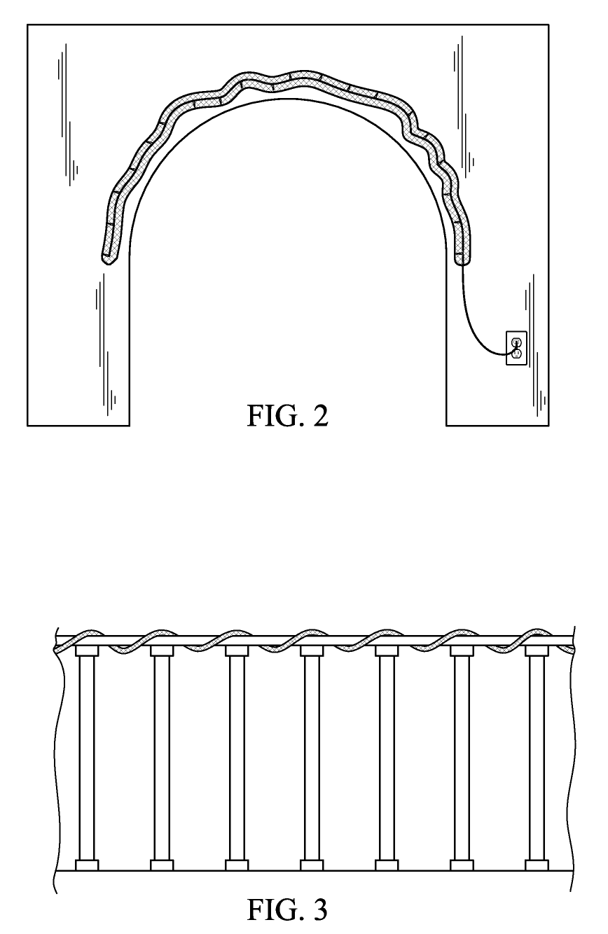

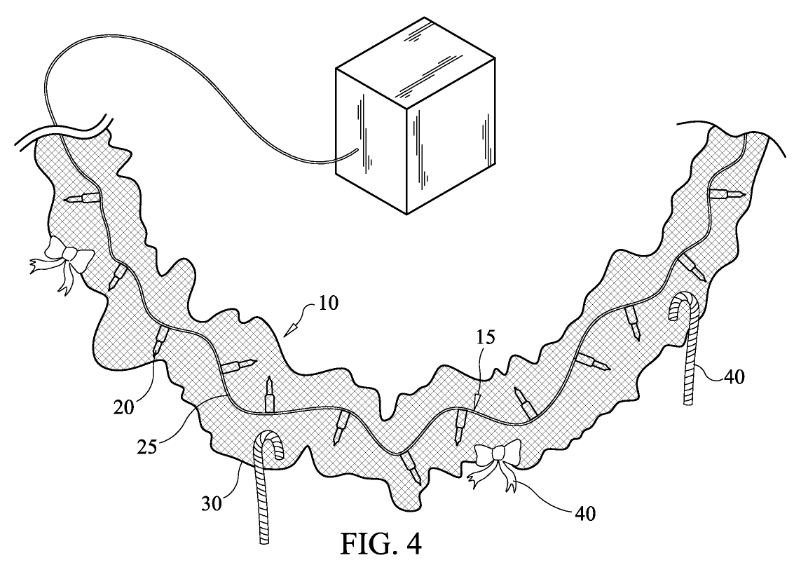

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is a decorative lighting article 10. It includes a string of lights 15 connected via a connecting member 25. The string of lights 15 may be a standard string of miniature electrical lamps 20. However, any other light sources may be used, such as any miniature bulbs or LEDs. They can be in any particular arrangement, and in any color or combination of colors desired.

The string of lights 15 is substantially surrounded by a sleeve 30 such as a mesh sleeve 30. The sleeve 30 may have openings at its ends to allow the string of lights 15 to be placed through it. The mesh sleeve 30 may be any suitable material. Preferably, it is a non-flammable material. The mesh sleeve is ideally irregularly shaped and flexible. A nylon mesh material may be used for the mesh sleeve, although any flexible material which is suitable is envisioned within the scope of the present invention.

The mesh sleeve 30 may be translucent. Thus, light is diffused through it and it provides a unique appearance. Optionally, the mesh can be semi-transparent or clear. It may be a net-like material. The mesh sleeve 30 can be of any desired color, such as white or colored, or multi-color.

The string of lights may be powered in any suitable fashion, such as via AC electrical power or batteries. The connecting member 25 may be a wire or pair of wires electrically connecting the light sources to a power source.

The article, including the string of lights and mesh sleeve, can then be used to decorate. For example, they can be wrapped around or attached to items to decorate them on holidays or other occasions.

Additional decorative items 40, such as trinkets or ribbons can be attached to the exterior of the mesh sleeve to increase appeal and decorative options. They may be attached in any suitable manner, such as via clips, sewing, hooks, Velcro, glue, etc.

While the specific embodiments have been illustrated and described, numerous modifications come to mind without significantly departing from the spirit of the invention, and the scope of protection is only limited by the scope of the accompanying claims.

What is claimed is:

1. A decorative lighting article comprising:
a string of lights comprising a plurality of light sources connected in linear arrangement via an elongated connecting member,
a sleeve substantially surrounding said string of lights.

2. The decorative lighting article according to claim 1, wherein said sleeve is a mesh sleeve formed of a flexible material.

3. The decorative lighting article according to claim 1, wherein said sleeve is irregularly shaped.

4. The decorative lighting article according to claim 1, wherein said sleeve is formed of a nylon material.

5. The decorative lighting article according to claim 1, wherein said sleeve is at least translucent, and wherein light from said light sources is diffused within said mesh sleeve.

6. The decorative lighting article according to claim 1, wherein said sleeve is semi-transparent.

7. The decorative lighting article according to claim 1, wherein said sleeve is clear.

8. The decorative lighting article according to claim 5, wherein said sleeve is white in color.

9. The decorative lighting article according to claim 5, wherein said sleeve is colored.

10. The decorative lighting article according to claim 1, further comprising a decorative item attached to the exterior of said sleeve.

11. The decorative lighting article according to claim 10, wherein said decorative item is a ribbon.

12. The decorative lighting article according to claim 10, wherein said decorative item is a trinket.

13. The decorative lighting article according to claim 5, wherein said light sources are miniature bulbs.

14. The decorative lighting article according to claim 13, wherein said elongated connecting member is an electrical conductor operatively connecting said bulbs to a power source.

15. The decorative lighting article according to claim 1, wherein said sleeve is formed of a non-flammable material.
